(19) United States
(12) Patent Application Publication
(10) Pub. No.: US 2013/0252074 A1
(43) Pub. Date: Sep. 26, 2013

(54) BATTERY MODULE

(71) Applicants: YI-WEN HSIAO, Hsin Chu City (TW); Ching-Ping Yao, Tao Yuan County (TW)

(72) Inventors: YI-WEN HSIAO, Hsin Chu City (TW); Ching-Ping Yao, Tao Yuan County (TW)

(21) Appl. No.: 13/617,565

(22) Filed: Sep. 14, 2012

(30) Foreign Application Priority Data
Mar. 21, 2012 (TW) 101109600

(51) Int. Cl. H01M 6/42; H01M 2/10

(52) U.S. Cl. 429/159

(57) ABSTRACT

A battery module includes a plurality of battery devices, a circuit board, a control board and a bus wire. The circuit board includes a circuit layout to which a plurality of conductive sheets of the battery devices are electrically connected. The bus wire is electrically connected between the circuit layout of the circuit board and the control board

### BACKGROUND OF THE INVENTION

1. Field of the Invention

The invention relates to a battery module, and more particularly, to a battery module capable of simplifying its internal structure.

2. Description of the Related Art

A lithium battery has a property of high energy density, and its applications have been expanded from low power electronic products to various high power electrical apparatuses, such as machine tools, E-Bike, E-Scott, and even large vehicles. The different electrical apparatuses require different electrical properties and there are huge differences in the shapes of different product applications; however, the smallest unit for all battery modules is a battery cell.

The sizes and electrical properties of the battery modules are different for different electrical apparatuses. According to prior arts, each individual battery module needs a dedicated battery casing and a plurality of battery cells are disposed outside the battery casing and connected in series via a plurality of metallic conductive sheets or wires.

Besides, the battery module further includes a control board. The battery cells coupled to the control board perform both charging and discharging operations via the control board. A plurality of wires need to be installed in order for the battery cells to connect with the control board. During a manufacturing process, the wires need to be connected or soldered between the control board and the battery cells, therefore increasing the process complexity and manufacturing working hours.

### SUMMARY OF THE INVENTION

An object of one embodiment of the invention is to provide a battery module. An object of one embodiment of the invention is to provide a battery module for simplifying its wiring structure.

According to one embodiment of the invention, a battery module is provided. The battery module includes a plurality of battery devices, a circuit board, a control board and a bus wire. Each battery device includes a plurality of battery cells and at least one conductive sheet for connecting the battery cells. The circuit board includes a circuit layout to which the conductive sheets of the battery devices are electrically connected. The control board is used to control the battery cells of the battery devices. The bus wire is electrically connected between the circuit layout of the circuit board and the control board to cause the control board to electrically connect with the battery devices via the circuit layout of the circuit board and the bus wire.

In one embodiment, the at least one conductive sheet of each of the battery devices extends toward the circuit board to electrically connect to the circuit layout of the circuit board.

In one embodiment, the circuit board further includes a printed circuit board and a first connector. The circuit layout is disposed on the printed circuit board. The first connector is disposed on the printed circuit board and electrically connected to the circuit layout. The control board further includes a second connector. The bus wire includes a third connector, a fourth connector and a connection wire. The connection wire is electrically connected between the third connector and the fourth connector. The structure of the third connector fits the structure of the first connector to assemble the third connector and the first connector. The structure of the fourth connector fits the structure of the second connector to assemble the fourth connector and the second connector.

In one embodiment, the battery module further includes at least one thermal sensor electrically connected to the circuit layout of the circuit board to electrically connect with the control board via the circuit layout of the circuit board and the bus wire.

In one embodiment, the circuit layout includes a plurality of conductive wiring lines and a plurality of conductive pads. The conductive wiring lines are electrically connected between the conductive pads and the first connector. The conductive pads are exposed on a surface of the printed circuit board. Each of the battery devices further includes a shell. The battery cells and the at least one conductive are disposed inside the shell The at least one conductive sheet extends out from the shell. The positions of the conductive sheets of the battery devices correspond to the conductive pads of the circuit layout, and the conductive sheets are electrically connected to the conductive pads respectively.

In one embodiment, the printed circuit board further delimits a plurality of openings, and the conductive sheets of the battery devices pass through the openings.

In one embodiment, the battery cells of each of the battery devices are connected in parallel via the at least one conductive sheet, and the battery devices are connected in series via the conductive sheets.

In one embodiment, the battery devices are stacked up, and the battery module further includes at least one stationary lid for fastening the stacked battery devices.

In one embodiment, the at least one conductive sheet of each of the battery devices extends along a first direction. The first direction extends toward an interior surface of the at least one stationary lid. The battery devices are stacked up along a second direction, and long axes of the battery cells of each of the battery devices extend along a third direction.

In one embodiment, the battery module further includes at least one screw. Each of the battery devices further delimits at least one screw hole, and an opening of the screw hole faces toward the at least one stationary lid. The at least one stationary lid delimits a plurality of through holes. The at least one screw is inserted into a corresponding screw hole by passing through a corresponding through hole.

In one embodiment, each of the battery devices further includes at least one convex positioning post, and the at least one convex positioning post protrudes toward the at least one stationary lid. The printed circuit board of the circuit board delimits a plurality of positioning holes for receiving the convex positioning posts respectively.

In one embodiment, the circuit board is located between the at least one stationary lid and the battery devices. The first connector of the circuit board faces toward the interior surface of the at least one stationary lid. The interior surface of the at least one stationary lid further delimits a fillister. The first connector of the circuit board and the bus wire are located in the fillister.

In one embodiment, the circuit board is located between the at least one stationary lid and the battery devices. The first connector of the circuit board faces toward the interior surface of the at least one stationary lid. The at least one stationary lid further delimits a through groove, and the first connector of the circuit board is located in the through groove and exposed from an exterior side surface of the at least one stationary lid.

As mentioned above, in one embodiment, the battery module includes a circuit board and at least one bus wire. The control board is electrically connected to the battery devices or the thermal sensor 512 via the circuit board and at least one bus wire. In one embodiment of the invention, due to the installation of the circuit board, the design of the control board can be simplified and modularized so that only different circuit boards need to be designed for different electrical apparatuses that can operate with the same control board. Furthermore, since most circuitry can be disposed on the circuit board, the connections among the components of the battery module can be simplified.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic diagram of a battery module according to one embodiment of the invention.

FIG. 2 shows a schematic diagram of a battery device according to one embodiment of the invention.

FIG. 3 shows a schematic diagram of a circuit board according to one embodiment of the invention.

### DETAILED DESCRIPTION OF THE INVENTION

In the following description of the invention, the term “A is coupled to B” or “A is electrically connected to B” refers to A that is coupled or electrically connected to B directly, or that is coupled or electrically connected to B indirectly via a material or a body to thereby make conductive between A and B. Besides, the term “A contacts B” refers to a direct contact or an indirect contact between A and B.

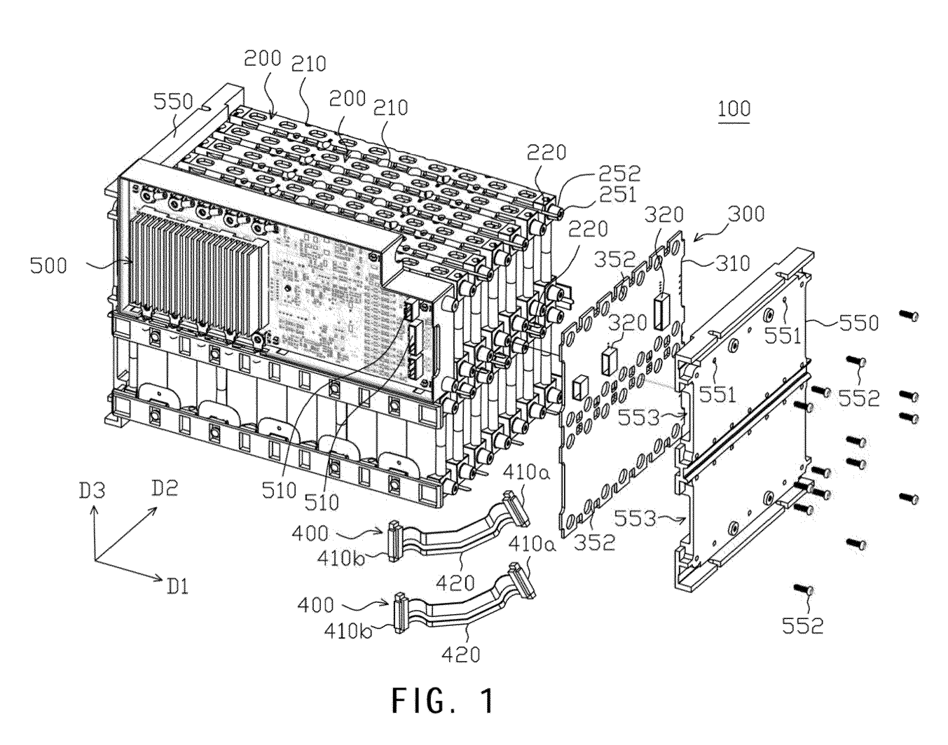

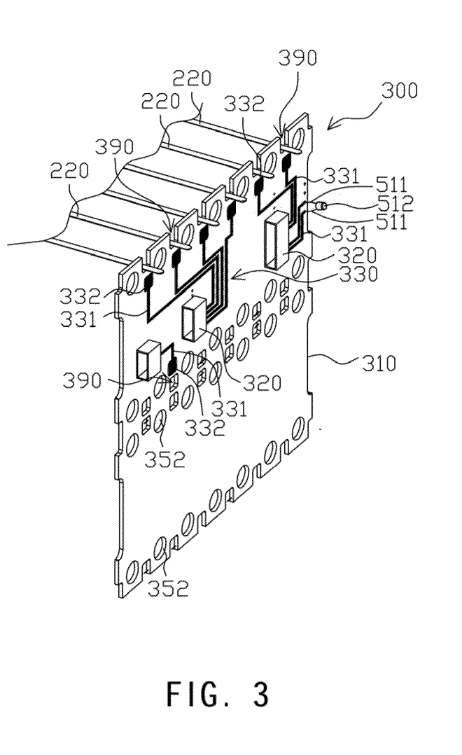

FIG. 1 shows a schematic diagram of a battery module according to one embodiment of the invention. As shown in FIG. 1, a battery module 100 includes a plurality of battery devices 200, a circuit board 300, at least one bus wire 400 and a control board 500. The control board 500 controls charging and discharging operations of the battery devices 200 via the circuit board 300 and the at least one bus wire 400. The battery devices 200 are electrically connected to a circuit layout (not shown, referring to FIG. 3) of the circuit board 300 while the at least one bus wire 400 is electrically connected between the circuit layout of the circuit board 300 and the control board 500, thereby to cause the battery devices to electrically connect with the control board 500. Such design can prevent from using an excessive amount of wires, simplify the internal structure of the battery module 100 and reduce the manufacturing working hours. The detailed structure according to one embodiment of the invention will be described more specifically as follows.

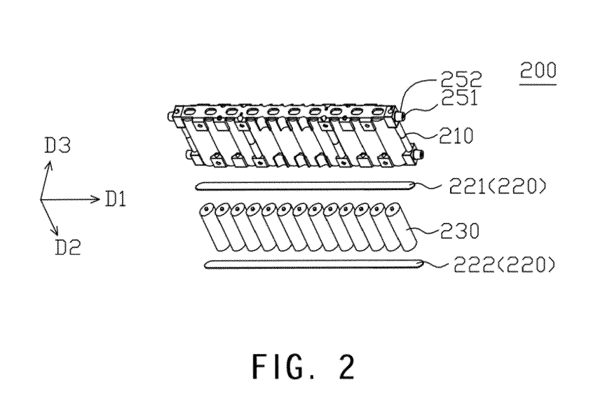

FIG. 2 shows a schematic diagram of a battery device according to one embodiment of the invention. As shown in FIG. 2, each battery device 200 includes at least one conductive sheet 220 and a plurality of battery cells 230. The battery cells 230 are electrically connected via the at least one conductive sheet 220. In one embodiment, the battery cells 230 are electrically connected in parallel via the at least one conductive sheet 220. More specifically, the positive electrodes of the battery cells 230 are all coupled to a first conductive sheet 221 while the negative electrodes of the battery cells 230 are all coupled to a second conductive sheet 222. In one embodiment, each battery device 200 further includes a shell 210. The battery cells 230 and the conductive sheets 221 and 222 are all disposed inside the shell 210; besides, the conductive sheets 221 and 222 extend from the interior of the shell 210 to its exterior (referring to FIGS. 1 and 3).

As shown in FIG. 1, the bus wire 400 includes a connection wire 420 and two connectors 410a and 410b. The connection wire 420 is electrically connected between the connectors 410a and 410b. The connector 410a is electrically connected to a connector 320 (referring to FIG. 3) of the circuit board 300 while the connector 410b is electrically connected to a connector 510 of the control board 500. The structure of the connector 510 of the control board 500 fits the structure of the connector 410b of the bus wire 400 so that the connector 410b can be assembled into the connector 510. The structures of the connector 510 and the bus wire 400 are well known in the art and can be implemented by existing or yet-to-be developed techniques; therefore, their detailed descriptions are omitted for the sake of brevity.

FIG. 3 shows a schematic diagram of a circuit board according to one embodiment of the invention. As shown in FIG. 3, the circuit board 300 includes a printed circuit board (PCB) 310, at least one connector 320 and a circuit layout 330. The at least one connector 320 and the circuit layout 330 are disposed on the circuit board 310, and the at least one connector 320 is electrically connected to the circuit layout 330. The structure of the connector 320 of the circuit board 300 fits the structure of the connector 410a of the bus wire 400 so that the connector 410a can be assembled into the connector 320. The structures of the connector 410a and the connector 320 are well known in the art and can be implemented by any existing or yet-to-be developed techniques; therefore, their detailed descriptions are omitted for the sake of brevity.

The circuit layout 330 disposed inside the PCB 310 includes a plurality of conductive wiring lines 331 and a plurality of conductive pads 332. The conductive pads 332 are exposed on the surface of the PCB 310 and located at the side edges or the middle part of the PCB 310. The position of each of the conductive pads 332 corresponds to one of the conductive sheets 220 extending out from the battery devices 200. The conductive wiring lines 331 are coupled between the conductive pads 332 and the at least one connector 320.

In one embodiment, the extending direction of the conductive sheets 220 forms a predetermined angle with the surface of the PCB 310, for example 90 degrees. During the manufacturing process, when the conductive sheets 220 are to electrically connect with the corresponding conductive pads 332, the conductive sheets 220 is bent so that the terminals of the conductive sheets 220 are in parallel with the surface of the PCB 310 to contact the corresponding conductive pads 332. In a preferred embodiment, the terminals of the conductive sheets 220 are further soldered on the conductive pads 332 to make the connections among the components of the battery module 100 more stable.

Besides, in one embodiment, a plurality of openings 390 are delimited in the side edges or the middle part of PCB 310. The positions of the openings 390 correspond to the conductive pads 332 and the terminals of the conductive sheets 220. As shown in FIG. 3, the terminals of the conductive sheets 220 extend out from the battery devices 200 and pass through the corresponding openings 390. Meanwhile, the terminals of the conductive sheets 220 are bent in order to contact the conductive pads 332. Since the openings 390 are able to provide positioning, the procedure of connecting the terminals of the conductive sheets 220 with the conductive pads 332 is simplified. In the embodiment of FIG. 3, the openings 390 can be notches (for example, at the side edges of the PCB 310). In one embodiment, the openings 390 can also be through holes (for example, in the middle part of the PCB 310).

In one embodiment, the battery module 100 further includes at least one thermal sensor 512. The thermal sensor 512 is electrically connected to two conductive wiring lines 331 of the circuit layout 330 via two wires 511 respectively. By such a design, the thermal sensor 512 can provide a thermal signal for the control board 500 via the circuit board 300 and the at least one bus wire 400. The control board 500 can detect the temperature of the whole battery module 100 according to the thermal signal provided by the thermal sensor 512. The installation position of the thermal sensor 512 as shown in FIG. 3 is provided by way of example and not limitation of the invention. In one embodiment, the thermal sensor 512 can be installed at any corner of the battery module 100, and the two wires 511 are installed in such a manner that the two wires 511 are coupled between the circuit layout 330 and the thermal sensor 512. Such design can simplify the circuit layout of the control board 500 to easily offer a modularization of the control board 500.

Furthermore, the invention is not limited to any particular connection methods of the battery devices 200 or the battery cells 230. A serial connection method according to one embodiment of the invention is described in detail as follows. As shown in FIG. 2, in one embodiment, the battery device 200 is regarded as an assembly unit to cause the battery cells 230 to connect in parallel. In other words, the positive electrodes of the battery cells 230 are all coupled to the first conductive sheet 221 while the negative electrodes of the battery cells 230 are all coupled to the second conductive sheet 222. In such a structure, the voltage of the battery device 200 is roughly equal to that of one battery cell 230. Depending on different electrical requirements of different electrical apparatuses, the voltage of the battery module 100 can be increased by connecting a plurality of battery devices 200 in series by using the conductive sheets 220. The structures of connecting a plurality of battery devices 200 in series are well known in the art and can be implemented by any existing or yet-to-be developed techniques; therefore, their detailed descriptions are omitted for the sake of brevity.

In one embodiment, the conductive sheets 220 of each battery device 200 all extend toward the circuit board 300 to electrically connect with the circuit layout 330 of the circuit board 300 so that it is convenient to assemble the components of the battery devices 200. More specifically, as shown in FIGS. 1 and 2, in each of the battery devices 200 of one embodiment, when the battery cells 230 and the conductive sheets 220 (221 and 222) are disposed inside the shell 210, the long axes (the direction from the negative electrode to the positive electrode, or the direction from the positive electrode to the negative electrode) of the battery cells 230 extend along the direction of 03 while the conductive sheets 220 extend along the direction of D1. As shown in FIG. 1, when the battery devices 200 are stacked up toward the direction of a side edge, the stacked battery devices 200 extend along the direction of D2. When the battery devices 200 are stacked up toward the vertical direction, the stacked battery devices 200 extend along the direction of D3.

In one embodiment, the battery module 100 further includes at least one stationary lid 550. Take two stationary lids 550 for example. The stacked battery devices 200 are clamped between the two stationary lids 550 to fix the assembly of the stacked battery devices 200 and stabilize the structure. More specifically, as shown in FIG. 1, the battery module 100 further includes at least one screw 552. The battery devices 200 further delimit a screw hole 251 with its opening facing toward the stationary lids 550. The normal lines of the stationary lids 550 are roughly in parallel to the direction of D1. The stationary lids 550 delimit a plurality of through holes 551. The screw 552 passes through a corresponding through hole 551 and is inserted into a corresponding screw hole 251.

In one embodiment, the battery devices 200 further includes at least one convex positioning post 252. The convex positioning post 252 protrudes from the battery devices 200 along the direction of D1. In one embodiment, the convex positioning post 252 can also delimit the screw hole 251. The circuit board 300 delimits a plurality of positioning holes 352. During the manufacturing process, the convex positioning posts 252 of the battery devices 200 can be respectively disposed in the positioning holes 352 of the circuit board 300 so that the battery devices 200 can be fastened in place with the circuit board 300. In one embodiment, the circuit board 300 is disposed between the battery devices 200 and one stationary lid 550; besides, the connector 320 of the circuit board 300 faces toward the interior surface of the stationary lid 550. In a preferred embodiment, the interior surface of the stationary lid 550 can delimit a fillister 553 to thereby delimit a containing space between the stationary lid 550 and the circuit board 300. The connector 320 of the circuit board 300 and the bus wire 400 are located in the containing space (or the fillister 553).

In one embodiment, the fillister 553 is a through groove which passes through the interior and exterior surfaces of the stationary lid 550. In other words, the stationary lid 550 further delimits a through groove. The connector 320 of the circuit board 300 is located in the through groove and exposed from the outer side surface of the at least one stationary lid 550. Such design can prevent a situation that the fillister 553 does not have enough containing space to accommodate the connector 320 and the bus wire 400.

In sum, the battery module 100 includes a circuit board 300 and at least one bus wire 400. The control board 500 is electrically connected to the battery devices 200 or to the thermal sensor 512 through the circuit board 300 and at least one bus wire 400. In one embodiment of the invention, due to the installation of the circuit board 300, the design of the control board 500 can be simplified and modularized so that only different circuit boards 300 need to be designed for different electrical apparatuses that can operate with the same control board 500. Furthermore, since most circuitry can be disposed on the circuit board 300, the connections among the components of the battery module 100 can be simplified.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinary skilled in the art.

1. A battery module, comprising:
a plurality of battery devices, each comprising:
a plurality of battery cells; and
at least one conductive sheet for connecting the battery cells;
a circuit board comprising a circuit layout and not having a function of controlling the battery cells of the battery devices, wherein the conductive sheets of the battery devices extend toward the circuit board to electrically connect with the circuit la out of the circuit board;
a control board for controlling the battery cells of the battery devices; and
a bus wire electrically connected between the circuit layout of the circuit board and the control board to cause the control board to electrically connect with the battery devices via the circuit layout of the circuit board and the bus wire,
wherein the conductive sheets of the battery devices are not connected to the control board and the bus wire is not connected to the battery devices.

2. (canceled)

3. The battery module according to claim 1, wherein the circuit board further comprises:
a printed circuit board, wherein the circuit layout is disposed on the printed circuit board; and
a first connector disposed on the printed circuit board for electrically connecting to the circuit layout;
wherein the control board further comprises a second connector; and wherein the bus wire comprises:
a third connector, whose structure fits a structure of the first connector to assemble the third connector and the first connector;
a fourth connector, whose structure fits a structure of the second connector to assemble the fourth connector and the second connector; and
a connection wire electrically connected between the third connector and the fourth connector.

4. The battery module according to claim 3, further comprising:
at least one thermal sensor electrically connected to the circuit layout of the circuit board to thereby electrically connect to the control board via the circuit layout of the circuit board and the bus wire.

5. The battery module according to claim 3, wherein the circuit layout comprises a plurality of conductive wiring lines and a plurality of conductive pads, wherein the conductive wiring lines are electrically connected between the conductive pads and the first connector, wherein the conductive pads are exposed on a surface of the printed circuit board, wherein each of the battery devices further comprises a shell, wherein the battery cells and the at least one conductive sheet are disposed inside the shell, wherein the at least one conductive sheet extends out from the shell, and wherein positions of the conductive sheets of the battery devices correspond to the conductive pads of the circuit layout and the conductive sheets are electrically connected to the conductive pads respectively.

6. The battery module according to claim 5, wherein the printed circuit board further delimits a plurality of openings, and wherein the conductive sheets of the battery devices pass through the openings.

7. The battery module according to claim 5, wherein the battery cells of each of the battery devices are connected in parallel via the at least one conductive sheet, and Wherein the battery devices are connected in series via the conductive sheets.

8. The battery module according to claim 5, wherein the battery devices are stacked up and the battery module further comprises at least one stationary lid for fastening the stacked battery devices.

9. The battery module according to claim 8, wherein the at least one conductive sheet of each of the battery devices extends along a first direction, wherein the first direction extends toward an interior surface of the at least one stationary lid, wherein the battery devices are stacked up along a second direction, and wherein long axes of the battery cells of each of the battery devices extend along a third direction.

10. The battery module according to claim 8, wherein the battery module further comprises at least one screw, wherein each of the battery devices further delimits at least one screw hole, wherein an opening of the screw hole faces toward the at least one stationary lid, wherein the at least one stationary lid delimits a plurality of through holes, and wherein the at least one screw is inserted into a corresponding screw hole by passing through a corresponding through hole.

11. The battery module according to claim 8, wherein each of the battery devices further comprises at least one convex positioning post, wherein the at least one convex positioning post protrudes toward the at least one stationary lid, and wherein the printed circuit board of the circuit board delimits a plurality of positioning holes for receiving the convex positioning posts respectively.

12. The battery module according to claim 11, wherein the circuit board is located between the at least one stationary lid and the battery devices, wherein the first connector of the circuit board faces toward the interior surface of the at least one stationary lid, wherein the interior surface of the at least one stationary lid further delimits a fillister, and wherein the first connector of the circuit board and the bus wire are located in the fillister.

13. The battery module according to claim 11, wherein the circuit board is located between the at least one stationary lid and the battery devices, wherein the first connector of the circuit faces toward the interior surface of the at least one stationary lid, wherein the interior surface of the at least one stationary lid further delimits a through groove, and wherein the first connector of the circuit board is located in the through groove and exposed from an exterior surface of the at least one stationary lid.
